(19) United States
(12) Patent Application Publication
(10) Pub. No.: US 2020/0113150 A1
(43) Pub. Date: Apr. 16, 2020

(54) Sticky Mats for Catching Pet Litter

(71) Applicant: Litter Picker Sticker LLC., Redmond, WA (US)

(72) Inventor: Ryfka Marlena Schafer, Redmond, WA (US)

(21) Appl. No.: 16/159,374

(22) Filed: Oct. 12, 2018

(51) Int. Cl. A01K 1/01; A01K 1/015

(52) U.S. Cl. CPC A01K 1/0114; A01K 1/0157

(57) ABSTRACT

Described herein are sticky mats and methods for using sticky mats to reduce the mess associated with pieces of litter being ejected from litter boxes during use. As described, a sticky mat that includes one or more adhesive sheets may be placed adjacent to a litter box such that litter that is ejected by a pet (or otherwise) from the litter box adheres to the adhesive sheet, rather than landing on a floor around the box. In some instances, the litter box includes multiple removable adhesive sheets, such that a pet owner may remove (e.g., tear off) and dispose of a top adhesive sheet when it has been dirtied with litter, so as to expose a fresh adhesive sheet for use.

### BACKGROUND

Litter boxes are often used by pet owners to provide an indoor location for pets to relieve themselves, such that they need not resort to carpeted or other finished areas of the pet-owner homes. As is known, litter boxes are typically filled with loose, granular material that absorb odors that would otherwise emanate from the urine of feces deposited into the litter. Some pets, such as domestic cats, use their paws in a backward sweeping motion when defecating inside a litter box for the purpose of covering their feces with the litter, akin to how these animals would do in sand or soft soil in nature. Unfortunately, this instinctive desire can cause litter to fly from the litter box and onto the floor on which the litter box resides.

### BRIEF DESCRIPTION OF THE DRAWINGS

The detailed description is described with reference to the accompanying drawings. In the figures, the left-most digit(s) of a reference number identifies the figure in which the reference number first appears. The use of the same reference numbers in different figures indicates similar or identical components or features.

FIG. 1 is a perspective view of a sticky mat configured to reside adjacent a litter box and adhere to litter that is ejected by a pet using the litter box.

FIG. 2 is a top view of a system that includes the sticky mat as well as a litter box residing within a cutout of the sticky mat such that the sticky mat receives the litter that is ejected from the litter box.

FIG. 3 is a side view of the sticky mat showing a bottom substrate and multiple removable adhesive sheets atop the bottom substrate.

FIG. 4 is a perspective view of another implementation of the sticky mat. In this implementation, the sticky mat comprises a raised-lip portion around a perimeter of the sticky mat to aid in the catching of lifter ejected from an adjacent litter box.

FIG. 5 is a flow diagram of an example process for using a sticky mat to catch litter ejected from an adjacent litter box.

### DETAILED DESCRIPTION

As described above, litter boxes are helpful in providing an indoor location for domesticated pets, such as cats, rabbits, ferrets, miniature pigs, small dogs, and the like. However, when these pets use the litter box, they sometimes use their legs to kick or otherwise project litter out of the box and onto the surrounding flooring surface, generating a mess for their respective owners. Further, in some instances the pets may “track” onto the floor pieces of litter that have stuck to the bottom of their feet. Again, this may create an undesired mess around the area in which the litter box resides.

Described below are sticky mats and methods for using sticky mats to reduce the mess associated with pieces of litter being ejected from litter boxes during use. As described below, a sticky mat that includes one or more adhesive sheets may be placed adjacent to a litter box such that litter that is ejected by a pet (or otherwise) from the litter box adheres to the adhesive sheet, rather than landing on a floor around the box. In some instances, the litter box includes multiple removable adhesive sheets, such that a pet owner may remove (e.g., tear off) and dispose of a top adhesive sheet when it has been dirtied with litter, so as to expose a fresh adhesive sheet for use.

In some instances, the sticky mat may include a cutout region such that multiple edges of a litter box are able to abut to multiple edges of the sticky mat. The cutout region thus allows the sticky mat to capture ejected lifter at a greater radius relative to an opening in the litter box. In still other instances, the sticky mat may include a raised portion (e.g., a lip) around a majority or substantially all of a perimeter of the sticky mat. This raised portion may function to act as a fence or guard, causing an even greater amount of lifter that is ejected from the litter box to remain on the sticky pad. In some instances, the sticky mat includes the raised portion, while in other instances the sticky mat is placed inside a receiving mat (e.g., made of plastic, metal, etc.) that includes the raised portion. While several example sticky mats are described below, it is to be appreciated that these are merely illustrative and that the claimed sticky mats may have other shapes and/or features.

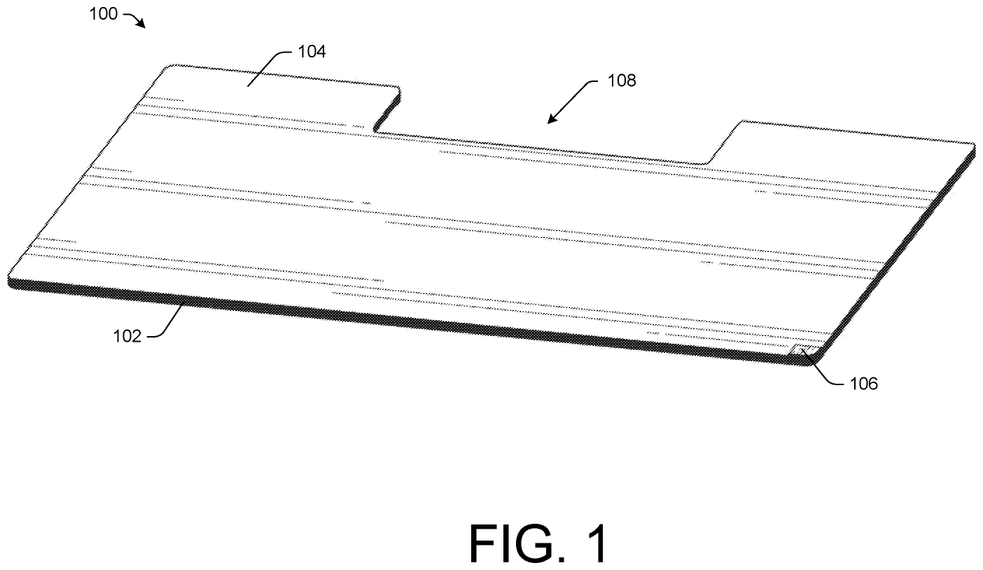

FIG. 1, for instance, is a perspective view of an example implementation of a sticky mat 100 configured to reside adjacent a litter box and adhere to litter that is ejected by a pet using the litter box. As illustrated, the sticky mat 100 is generally rectangular shaped, although other implementations may have any other shape, such as circular, polygonal, or the like. Further, the sticky mat 100 may include a bottom substrate 102 that resides near a flooring surface, as well as one or more adhesive layers or sheets 104 for catching ejected litter. In some instances, the sticky mat 100 includes multiple, removable adhesive sheets that each include a top surface having an adhesive film and a bottom surface that is free from the adhesive film. The adhesive film on the top surface may function to capture any litter that a pet ejects onto the mat 100. Further, when an owner of the pet decides that the sticky mat 100 is full or otherwise is to be replaced, the owner may tear off the top adhesive sheet to expose the top surface of another underlying adhesive sheet that includes the adhesive film on its top surface. The owner may then dispose of the removed sheet. In some instances, each adhesive sheet couples to the bottom substrate 102, to an underlying adhesive sheet, and/or to another structural element and includes a perforated edge for enabling the tearing off of the respective sheet. In some instances, the perforation resides proximate an edge of the sticky mat 100.

As illustrated, the sticky mat 100 may include a cutout region 108 designed to receive a litter box. That is, the sticky mat 100 may be designed to include a region, such as the cutout region 108 to receive a litter box such that multiple edges of the litter box abut to respective multiple edges of the sticky mat 100. For instance, in the illustrated example a front edge of the lifter box may abut to the longer edge of the cutout region 108 of the mat 100, while a portion of a left side and a right side of the litter box may abut to the respective shorter edges of the cutout region 108. In some instances, this region may reside along a longer edge of the rectangular-shaped mat 100, as in the illustrated implementation. It is noted that the cutout region 108 may be sized such that the litter box touches or nearly touches each edge of the cutout region so that no or very litter flooring surface is exposed between the litter box and the sticky mat 100. In some instances, different sticky mats 100 may have different sized and oriented cutout regions 108 to accommodate differently sized litter boxes. Regardless of the exact configuration of the cutout region 108, by enabling multiple sides of the litter box to abut to the sticky mat 100, the cutout region 108 may result in a sticky mat that captures a greater amount of litter than if a single edge of the litter box were to abut to the sticky mat 100. Stated otherwise, the cutout region 108 provides greater angular coverage of ejected litter than if the sticky mat 100 did not include the region 108.

As noted above, the sticky mat 100 may include multiple, tearaway adhesive sheets 104. In some instances, one or more of the sheets 104 include a numerical indicator 108 indicating the number of the sheet. In some instances, each of the sheets 104 includes a respective numerical indicator that is numerically contiguous to each adjacent sheet (e.g., 1, 2, 3, . . . ). These numerical indicators thus allow an owner of the pet to understand how many adhesive sheets remain before a new sticky mat 100 is to be acquired. In some instances, the adhesive sheets may count upwards, such that the first sheet is numbered “1”, the second is numbered “2”, and so forth, while in other instances the sheets may be “countdown” such that when the owner reaches “1” they know they are using the last adhesive sheet. For instance, if the sticky mat 100 includes twenty (20) sheets, the first sheet may be labeled “20” and the last sheet may be labeled “1”.

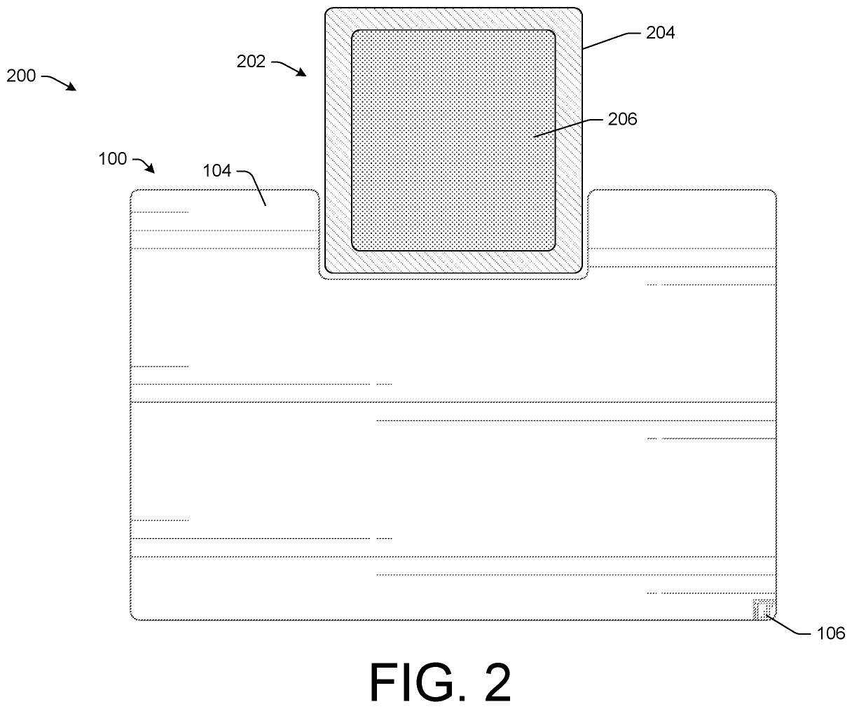

FIG. 2 is a top view of a system 200 that includes the sticky mat 100 as well as a litter box 202 residing within a cutout region of the sticky mat 100 such that the sticky mat receives litter 206 that is ejected from the litter box. FIG. 2, for instance, illustrates the pieces of litter 206(1), 206(2), and 206(3) have been captured by the exposed adhesive sheet 104. In some instances, the litter box 202 may be positioned such that an opening of a housing 204 of the litter box points towards the sticky mat 100 (points downwards in the illustration) such that the sticky mat is positioned to receive the ejected litter.

Further, while FIG. 2 illustrates a single sticky mat 100 on one side of the litter box 202, it is to be appreciated that in other instances multiple sticky mats may be used for a single litter box, or a single sticky mat 100 may be used to accommodate multiple litter boxes (e.g., a single mat 100 may include multiple cutout regions, each for receiving a respective litter box). In still other instances, the cutout region of a sticky mat may be substantially in a center of the sticky mat 100 such that the litter box 202 is effectively surrounded by the sticky mat 100. For instance, the sticky mat 100 may be a rectangular- or circular-shaped mat that is meaningfully larger (e.g., two times as big in surface area, etc.) as the litter box, such that the sticky mat 100 is able to capture litter 206 ejected from any angle of the litter box 202. This configuration may be helpful in instances where the litter box 202 does not include an upper housing having a single opening, but instead comprises a tub such that the pet is able to eject the lifter 206 in any direction

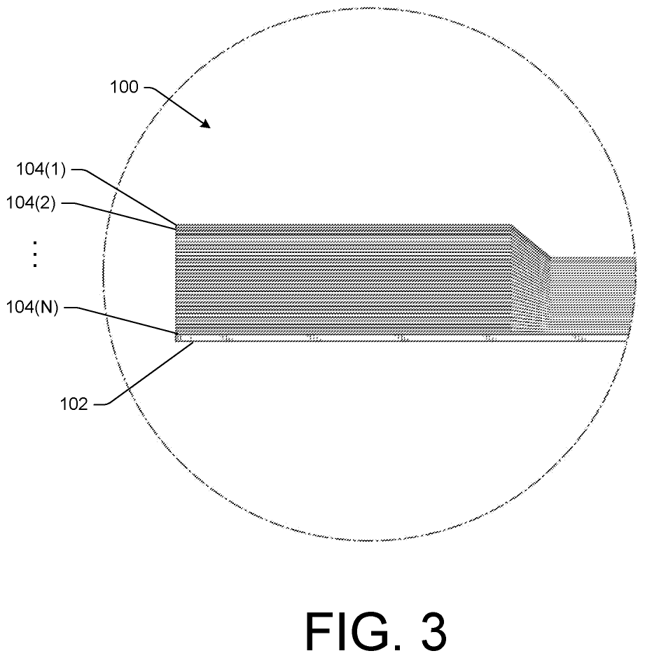

FIG. 3 is a side view of the sticky mat 100 showing the bottom substrate 102 and multiple removable adhesive sheets 104(1), (2), . . . , (N) atop the bottom substrate 102. As described above, the top surface of each adhesive sheet 104 may comprise an adhesive film while, a bottom surface of each sheet 104 may be free from the film. Further, the bottom substrate 102 may comprise a bottom surface having the adhesive film (or a different type of adhesive), and a top surface that is free from the adhesive film. In some instances, the bottom surface of the bottom substrate 102 may include a cover (e.g., a non-adhesive plastic cover) that is initially adhered to the bottom surface but that a user is to remove prior to adhering the sticky mat 100 to the desired flooring surface in their house or other building.

In some instances, each of the adhesive sheets 104 comprises a tear-off polyethylene sheet that is substantially clear and non-toxic. For example, the sticky mat 100 may utilize a water-based acrylic adhesive having a relatively neutral pH level (e.g., approximately 7-8) that is free of benzoic acid. This non-toxic adhesive material is thus safe for both pets and humans (e.g., children) in the home. In some instances, the sticky mat 100 may be formed from a sticky mat sold under the trade name ERGOMAT®, although any other type of sticky mat 100 may be used. For example, the sticky mats 100 described herein may be formed from any other type of material, such as plastic, carboard or other paper products, and the like, while any type of adhesive may be used both as part of the adhesive sheets 104 and as part of the bottom surface of the bottom substrate 102.

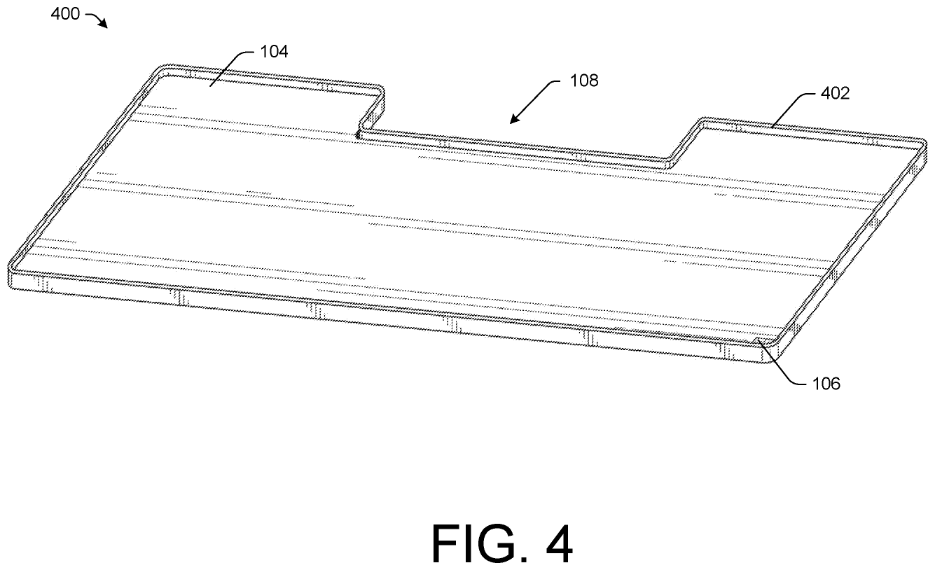

FIG. 4 is a perspective view of another implementation of a sticky mat 400. In this implementation, the sticky mat 400 comprises a raised-lip portion 402 around a perimeter of the sticky mat 400 to aid in the catching of litter ejected from an adjacent litter box. In some instances, the raised-lip portion 402 is integral with the sticky mat (i.e., is formed as part of the bottom substrate 102, adhesive sheets 104, etc.). In other instances, meanwhile, the raised-lip portion may be separate from the bottom substrate 102, adhesive sheets 104, etc. For example, the raised-lip portion 402 may be part of a receiving mat having the raised perimeter (402) and an interior portion for receiving the sticky mat 100 shown in FIG. 1. That is, the raised-lip portion 402 may comprise, for example, a plastic, cardboard, or metal component into which the sticky mat 100 is placed. In still other instances, the raised-lip portion 402 may be a plastic, carboard, or metal component having no interior but that resides around the sticky mat 100. That is, the raised-lip portion 402 may be akin to a “cookie cutter” that sits around the sticky mat 100. In each of these instances, the term “sticky mat” may be used to refer to a sticky mat that is free from the raised-lip portion 402 (e.g., the sticky mat 100), a sticky mat that is integral with the raised-lip portion 402, and/or a system that includes the former (e.g., the sticky mat 100) and a receiving mat or cookie-cutter-like raised-lip portion 402.

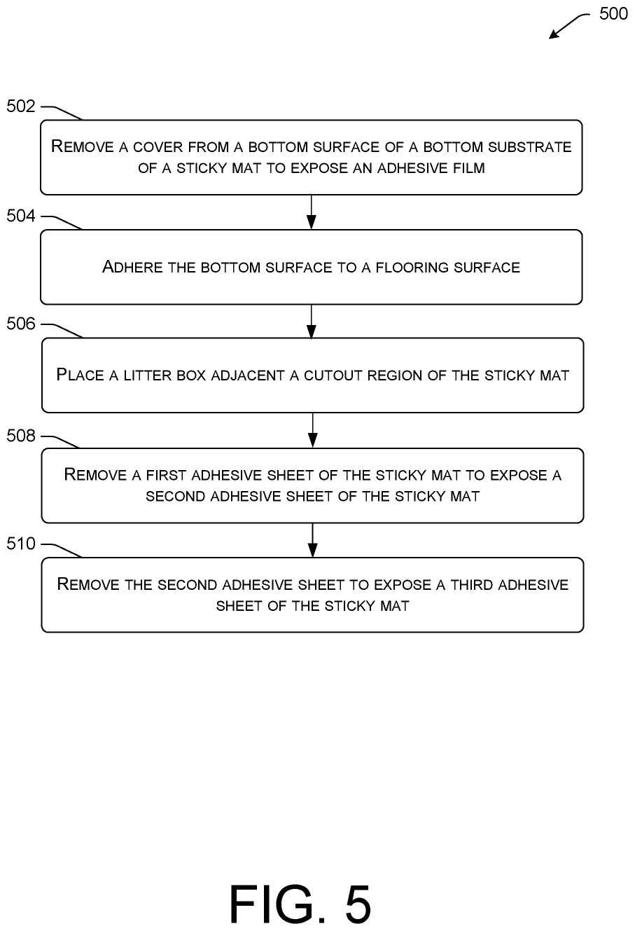

FIG. 5 is a flow diagram of an example process 500 for using a sticky mat to catch litter ejected from an adjacent litter box. At an operation 502, a user may remove a cover from a bottom surface of a bottom substrate of a sticky mat to expose an adhesive film. Thereafter, at an operation 504 the user may adhere the bottom surface of the bottom substrate to a desired flooring surface. For example, the user may choose to locate the sticky mat in a corner of a kitchen of the user, or the like. At an operation 506, the user may place a litter box adjacent to a cutout region of the sticky mat. That is, the user may position the litter box so that multiple edges of the litter box abut to respective multiple edges of the cutout region of the sticky mat. It is to be appreciated that, in some instances, the user may first position the litter box before positioning the sticky mat around the litter box.

In either instance, at an operation 508 the user may thereafter remove a first adhesive sheet of the sticky mat to expose a second adhesive sheet. That is, after a pet has dirtied the top adhesive sheet through use (e.g., through the capturing of ejected or tracked litter), the user may choose to remove and dispose of the top adhesive sheet. An operation 510 represents that after the second adhesive sheet has been similarly dirtied, the user may remove the second adhesive sheet to expose a third adhesive sheet, and so forth.

Although the subject matter has been described in language specific to structural features, it is to be understood that the subject matter defined in the appended claims is not necessarily limited to the specific features described. Rather, the specific features are disclosed as illustrative forms of implementing the claims.

What is claimed is:

1. A system comprising:
a litter box to receive animal litter; and
a sticky mat, comprising:
a bottom substrate comprising a top surface and a bottom surface, the bottom surface configured to adhere to a flooring surface on which the litter box resides;
a first adhesive sheet coupled to the top surface of the bottom substrate; and
a second adhesive sheet coupled to a top surface of the first adhesive sheet;
and wherein each of the top surface of the first adhesive sheet and a top surface of the second adhesive sheet comprises an adhesive film configured to adhere to animal litter ejected from the litter box.

2. The system as recited in claim 1, wherein the sticky mat comprises a substantially rectangular shape with a cutout on a side of the sticky mat for mating with one or more edges of the litter box.

3. The system as recited in claim 1, wherein the first adhesive sheet includes a first numerical indicator and the second adhesive sheet includes a second numerical indicator that is numerically contiguous to the first numerical indicator.

4. The system as recited in claim 1, wherein each of the first adhesive sheet and the second adhesive sheet includes a perforation proximate an edge of each respective adhesive sheet to enable the respective adhesive sheet to be torn off from the bottom substrate.

5. The system as recited in claim 1, wherein each of the first adhesive sheet and the second adhesive sheet comprises a polyethylene film.

6. The system as recited in claim 1, wherein each of a bottom surface of the first adhesive sheet and a bottom surface of the second adhesive sheet is free from the adhesive film.

7. The system as recited in claim 1, wherein the sticky mat further comprises a raised lip around at least a majority of a perimeter of the sticky mat.

8. A sticky mat for receiving animal litter ejected from a litter box, the sticky mat comprising:
a bottom substrate comprising a bottom surface configured to adhere to a flooring surface;
a first adhesive sheet coupled to a top surface of the bottom substrate and comprising a top surface having an adhesive film adhering to a first portion of the animal litter; and
a second adhesive sheet coupled to the top surface of the first adhesive sheet and comprising a top surface having the adhesive film for adhering to a second portion of the animal litter;
and wherein the sticky mat defines a two-dimensional shape that includes a cutout such that multiple edges of the sticky mat abut to multiple sides of the litter box.

9. The sticky mat as recited in claim 8, wherein the sticky mat defines a substantially rectangular shape having two parallel longer sides and to parallel shorter sides, and wherein the cutout resides on at least one of longer sides of the substantially rectangular shape.

10. The sticky mat as recited in claim 8, wherein the first adhesive sheet includes a first numerical indicator and the second adhesive sheet includes a second numerical indicator that is numerically contiguous to the first numerical indicator.

11. The sticky mat as recited in claim 8, wherein each of the first adhesive sheet and the second adhesive sheet includes a perforation proximate an edge of each respective adhesive sheet to enable the respective adhesive sheet to be torn off from the bottom substrate.

12. The sticky mat as recited in claim 8, wherein each of the first adhesive sheet and the second adhesive sheet comprises a polyethylene film.

13. The handheld controller as recited in claim 8, wherein each of a bottom surface of the first adhesive sheet and a bottom surface of the second adhesive sheet is free from the adhesive film.

14. The sticky mat as recited in claim 8, wherein the sticky mat further comprises a raised lip around at least a majority of a perimeter of the sticky mat.

15. A method comprising:
adhering a bottom substrate of a sticky mat to a flooring surface, the sticky mat including a cutout for receiving a litter box;
placing the litter box adjacent the cutout of the sticky mat such that the litter box abuts the sticky mat; and
removing a first adhesive sheet of the sticky mat to expose a second adhesive sheet, each of the first adhesive sheet and the second adhesive sheet including an adhesive film for adhering to animal litter ejected from the litter box.

16. The method as recited in claim 15, wherein the bottom substrate includes the adhesive film on a bottom surface of the bottom substrate, and further comprising removing a cover from the bottom substrate prior to adhering the bottom substrate to the flooring surface.

17. The method as recited in claim 15, further comprising removing the second adhesive sheet from the sticky mat to expose a third adhesive sheet, the third adhesive sheet including the adhesive film for adhering to animal litter ejected from the litter box.
